(19) United States
(12) Patent Application Publication
(10) Pub. No.: US 2010/0157479 A1
(43) Pub. Date: Jun. 24, 2010

(54) SLIDER, STORAGE DEVICE HAVING THE SLIDER, AND METHOD OF MANUFACTURING SUSPENSION ASSEMBLY HAVING THE SLIDER, AND STORAGE DEVICE

(75) Inventor: Kaoru ABIKO, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/718,756

(22) Filed: Mar. 5, 2010

Related U.S. Application Data
(63) Continuation of application No. PCT/JP2007/067395, filed on Sep. 6, 2007.

(51) Int. Cl. G11B 5/60; B32B 38/00

(52) U.S. Cl. 360/234.3; 156/245; G9B/5.229

(57) ABSTRACT

According to one embodiment, a slider of a head includes is configured to fly from a surface of a disk. The slider includes a floating surface configured to oppose the surface of the disk, a positive pressure section in the floating, configured to produce floating force in conjunction with airflow formed by a rotation of the disk, and a first identifying section having a height identical to that of the positive pressure section in the floating surface and configured to identify a gravity center position of positive pressure force generated by the positive pressure section in the floating surface.

### CROSS REFERENCE TO RELATED APPLICATIONS

This is a Continuation Application of PCT Application No. PCT/JP2007/067395, filed Sep. 6, 2007, which was published under PCT Article 21(2) in Japanese.

### BACKGROUND

1. Field

An embodiment of the invention relates to a slider in a disk drive, a storage device, and a method of manufacturing a suspension assembly having the slider.

2. Description of the Related Art

Recently there is an increasing demand for stable use of the compact hard disk drive (HDD) at the request of miniaturization and high performance of electronic device. In the HDD, the head records and reproduces the information in and from the disk while the (head) slider floats from the disk surface. When the disk rotates, airflow is generated, and the airflow produces buoyant force that causes the slider to float from the disk surface. On the other hand, a suspension supporting the slider comprises a projection, and applies elastic force (pressurizing force or load) facing the buoyant force of the slider to the slider through the projection. In the conventional HDD, a slider floating amount is controlled by a balance (that is, positive pressure=load) between the buoyant force (positive pressure) and the elastic force.

There is a risk that the floating amount is not stabilized in the conventional configuration, because the positive pressure is susceptible to air states such as concentration, temperature, humidity, and viscosity while the elastic force is kept constant. Therefore, there has been proposed a configuration in which a negative pressure section is provided in the slider such that the state of (positive pressure=negative pressure+load) is obtained. The negative pressure fluctuates by a characteristic of the air similarly to the positive pressure, and the fluctuation amount of the negative pressure cancels out the fluctuation amount of the positive pressure. As a result, advantageously the floating amount can be stabilized irrespective of the air state.

The positive pressure section and the negative pressure section are formed by performing exposure and etching processes to a slider surface (also referred to as “floating surface”) opposite the disk using different masks. Conventionally the slider is mounted on the suspension based on a tooling hole that is a reference hole of the suspension.

A center of the tooling hole of the suspension is disposed on a center axis in a longitudinal direction of the suspension. When the slider is mounted on the suspension, a distance between a side closest to a tooling hole of the slider and a center of the tooling hole is set to a distance. A center of a width of the slider is matched with the center axis, and a perpendicular bisector of the sides is matched with the center axis. An intersection of diagonals of a floating surface of the slider can be considered as an outline center of the floating surface of the slider.

A suspension comprises a projection that provides elasticity to the slider toward the disk, that is, downward in a Z-direction. When the slider is mounted on the suspension as described above, the outline center of the floating surface of the slider and a pressurizing point at which the projection of the suspension comes into contact with the slider are aligned with each other in the Z-direction, and a floating attitude is stabilized.

For example, Japanese Registered Utility Model Disclosure No. 2575926 discloses the conventional technique.

The slider is susceptible to the floating amount or the floating attitude with the progress of miniaturization. When the positive pressure section deviates from an original position due to an alignment error between the mask and the floating surface, the floating attitude of the slider is not stabilized even if the outline center of the slider and the pressurizing point are aligned with each other in the Z-direction by utilizing the tooling hole, thereby loosing the floating stability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view illustrating an internal structure of a hard disk drive according to an embodiment of the invention;

FIG. 2 is an exemplary enlarged plan view illustrating a magnetic head section of the hard disk drive of FIG. 1;

FIG. 3 is an exemplary enlarged plan view illustrating a modification of the magnetic head section of FIG. 2;

FIG. 4 is an exemplary enlarged plan view illustrating another modification of the magnetic head section of FIG. 2;

FIG. 5 is an exemplary enlarged plan view illustrating still another modification of the magnetic head section of FIG. 2;

FIG. 6 is an exemplary enlarged plan view illustrating another modification of the magnetic head section of FIG. 3;

FIG. 7 is an exemplary enlarged plan view illustrating still another modification of the magnetic head section of FIG. 4;

FIG. 8 is an exemplary flowchart illustrating a method for producing the hard disk drive of FIG. 1;

FIG. 9 is an exemplary flowchart illustrating the detailed process in Step 1010 of FIG. 8;

FIG. 10 is an exemplary schematic sectional view corresponding to each process of FIG. 9;

FIG. 11A is an exemplary plane view illustrating a suspension of the hard disk drive of FIG. 1;

FIG. 11B is an exemplary side view illustrating the suspension and the magnetic head section of the hard disk drive of FIG. 1; and

FIG. 12 is an exemplary schematic diagram illustrating a correction method when a gravity center position of positive pressure force deviates from that of negative pressure force.

### DETAILED DESCRIPTION

Various embodiments according to the invention will be described hereinafter with reference to the accompanying drawings. In general, according to one embodiment of the invention, there is provided a slider on which a head is mounted to record and reproduce information in and from a disk, the slider being configured to fly from a surface of the disk, the slider comprising: a floating surface configured to oppose the surface of the disk; a positive pressure section in the floating, configured to produce floating force in conjunction with airflow formed by a rotation of the disk; and a first identifying section having a height identical to that of the positive pressure section in the floating surface and configured to identify a gravity center position of positive pressure force generated by the positive pressure section in the floating surface.

As used herein, “the gravity center position of the positive pressure force generated by the positive pressure section in the floating surface” means that, when the floating surface position corresponding to the suspension pressurizing point, that is, the slider mounted on the suspension is driven while mounted on the storage device, the position identified by the first identifying section is points arrayed on the same straight line in the vertical direction of the pressurizing point. In a certain example, the floating surface position corresponding to the suspension pressurizing point is an outline center of the floating surface. In another example, the floating surface position corresponding to the suspension pressurizing point is a position offset from the outline center of the floating surface.

The first identifying section may have a circular shape when viewed from a direction perpendicular to the floating surface. When the circular shape is previously known, the center of the first identifying section is easy to find. The first identifying section may include one or a plurality of marks. The use of the two marks can set a midpoint of a line segment connecting the centers or gravity centers of the marks to a reference. The use of the three marks can set a gravity center, an incenter, or a circumcenter of a triangle connecting the centers or gravity centers of the marks to the reference. The reliability of position detection can be secured by redundancy. The slider may further comprise a wall section which defines a negative pressure section to reduce the floating force; and a second identifying section which has a height identical to that of the wall section in the floating surface to identify a gravity center position of negative pressure force generated by the negative pressure section in the floating surface. Not only the gravity center position of the positive pressure force, which is identified by the first identifying section, but also the gravity center position of the negative pressure force can be identified by providing the second identifying section. Therefore, the floating amount that is more stable than that of the slider in which only the first identifying section is provided can be obtained in consideration of the gravity center positions.

Another aspect of the invention provides a slider on which a head is mounted to record and reproduce information in and from a disk, the slider being able to float from a surface of the rotating disk and including a wall section in a floating surface opposite the disk, the wall section defining a negative pressure section to reduce floating force, the negative pressure section being formed farther away from the disk than a positive pressure section producing floating force in conjunction with airflow formed by the rotating disk. The slider comprises a second identifying section which has a height identical to that of the wall section in the floating surface to identify a position of the negative pressure section in the floating surface. The wall section can be identified by providing the second identifying section even if the wall section defining the negative pressure section is formed while deviated. Therefore, the position of the negative pressure section can be identified. The second identifying section may have a circular shape when viewed from a direction perpendicular to the floating surface. The second identifying section may include one or a plurality of marks.

In another aspect of the invention, a suspension assembly comprises the slider; and a suspension that comprises a projection, the suspension applying elastic force toward the disk to the slider while supporting the slider.

In an aspect of the invention, a storage device comprises the suspension assembly. In this case, both the floating surface position identified by the first identifying section and the pressurizing point at which the projection comes into contact with the slider are set to exist on an identical straight line parallel to a vertical direction. Therefore, an influence of the mask alignment error can be canceled in forming the positive pressure section.

In an aspect of the invention, a suspension assembly comprises the slider; and a suspension that comprises a projection, the suspension applying elastic force toward the disk to the slider while supporting the slider. In the suspension, both a moment center position and the pressurizing point at which the projection comes into contact with the slider exist on an identical straight line parallel to a vertical direction, the moment center position being computed from the floating surface position identified by the first identifying section and the positive pressure force and the floating surface position identified by the second identifying section and the negative pressure force. Therefore, an influence of the mask alignment error can be canceled in forming the positive pressure section and the negative pressure section.

Another aspect of the invention provides a method for manufacturing a suspension assembly comprising a slider on which a head is mounted to record and reproduce information in and from a disk, the slider being configured to fly from a surface of the disk and comprising a positive pressure section in a floating surface opposite the disk, configured to produce floating force in conjunction with airflow formed by a rotation of the disk; and a suspension configured to support the slider and apply elastic force toward the disk to the slider, the method comprising: manufacturing a slider comprising a floating surface and a positive pressure section, the manufacturing comprising forming a first identifying section with using an identical mask, the first identifying section being configured to identify a gravity center position of positive pressure force generated by the positive pressure section in the floating surface; and mounting the slider on a suspension having a projection configured to apply elastic force toward the disk to the slider.

In another aspect of the invention, a storage device manufacturing method comprises: manufacturing the suspension assembly; and mounting the suspension assembly on a chassis. In the storage device manufacturing method, in the manufacturing the slider, the influence of the mask alignment error can be involved in the first identifying section by forming the positive pressure section and the first identifying section with the identical mask. In mounting the slider, the slider is mounted on the suspension such that both the floating surface position identified by the first identifying section and the pressurizing point at which the projection comes into contact with the slider are set to exist on an identical straight line parallel to a vertical direction. Therefore, the influence of the mask alignment error can be canceled in forming the positive pressure section.

Another aspect of the invention provides a method of manufacturing a slider on which a head is mounted to record and reproduce information in and from a disk, the slider being configured to flay from a surface of the rotating disk and including a wall section in a floating surface opposite the disk, the wall section defining a negative pressure section to reduce floating force, the negative pressure section being formed farther away from the disk than a positive pressure section producing floating force in conjunction with airflow formed by the rotating disk. The slider producing method comprises a step of forming the wall section and a second identifying section with an identical mask, the second identifying section identifying a gravity center position of negative pressure force generated by the negative pressure section in the floating surface.

In another aspect of the invention, a storage device manufacturing method comprises: manufacturing the suspension assembly; and mounting the suspension assembly on a chassis. In the method, in the manufacturing slider, the influence of the mask alignment error can be involved in the second identifying section by forming the wall section and the second identifying section with the identical mask. The manufacturing the slider further comprises forming the positive pressure section and a first identifying section with the identical mask, the first identifying section identifying the gravity center position of the positive pressure force generated by the positive pressure section in the floating surface, and, in the mounting the slider, the slider is mounted on the suspension such that both a moment center position and the pressurizing point at which the projection comes into contact with the slider exist on the identical straight line parallel to the vertical direction, the moment center position being computed from the floating surface position identified by the first identifying section and the positive pressure force and the floating surface position identified by the second identifying section and the negative pressure force. Therefore, the influence of the mask alignment error can be canceled in forming the positive pressure section or the negative pressure section in the floating surface.

Other and further objects and features of the invention will be apparent by embodiments with reference to the accompanying drawings.

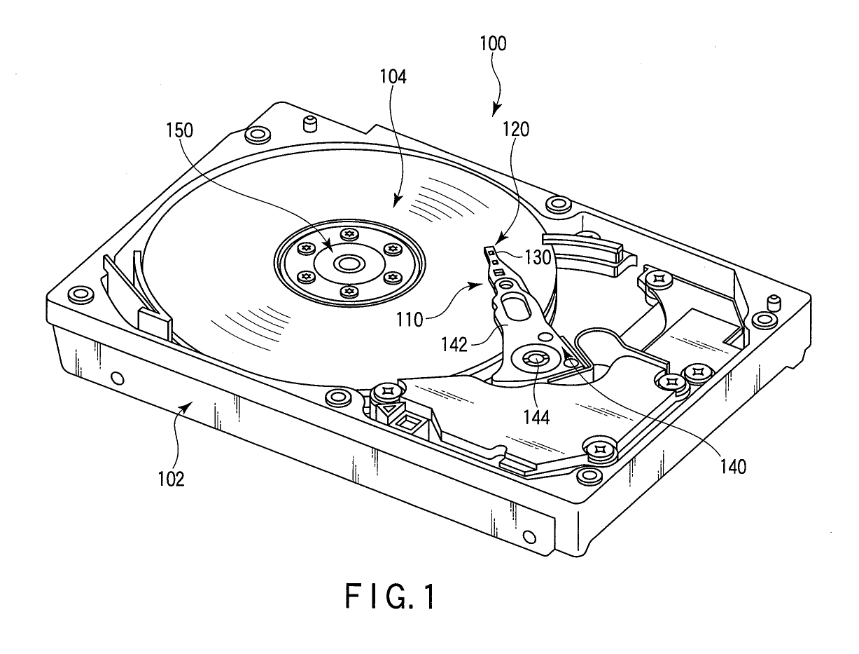

An HDD (storage device) 100 according to an embodiment of the invention will be described below with reference to the accompanying drawings. As illustrated in FIG. 1, one or plural magnetic disks 104 that are a recording medium, a head stack assembly (HSA) 110, and a spindle motor 150 are accommodated in a chassis 102 of the HDD 100. FIG. 1 is an exemplary schematic perspective view of an internal structure of the HDD 100.

For example, the chassis 102 having a rectangular shape is made of an aluminum die-cast base or stainless steel, and a top cover (not illustrated) is joined to the chassis 102 to seal an internal space thereof. For example, the magnetic disk 104 has high surface recording density of 100 Gb/in² or more. The magnetic disk 104 is mounted on a spindle of a spindle motor 150 through a hole made in the center thereof.

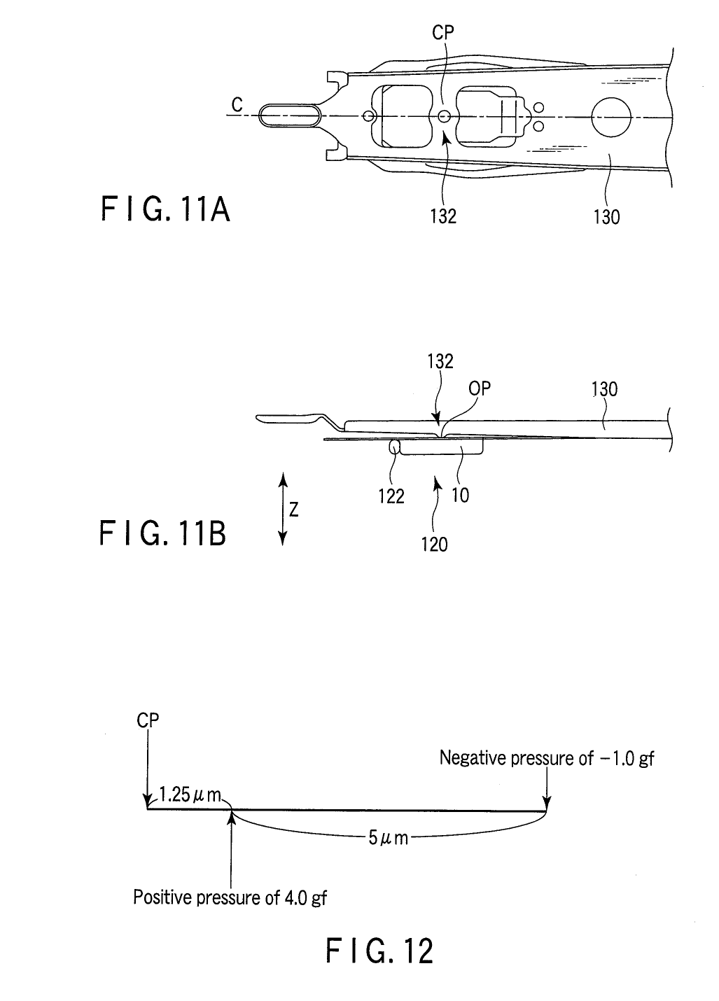

As shown in FIGS. 1, 11A and 11B, the HAS 110 comprises a magnetic head section 120, a suspension 130, and a carriage 140. Occasionally a member comprising the magnetic head section 120 and the suspension 130 is called a head gimbal assembly (HGA). In the embodiment, a suspension assembly is a concept including the magnetic head section 120, the suspension 130, the HAS, and the HGA.

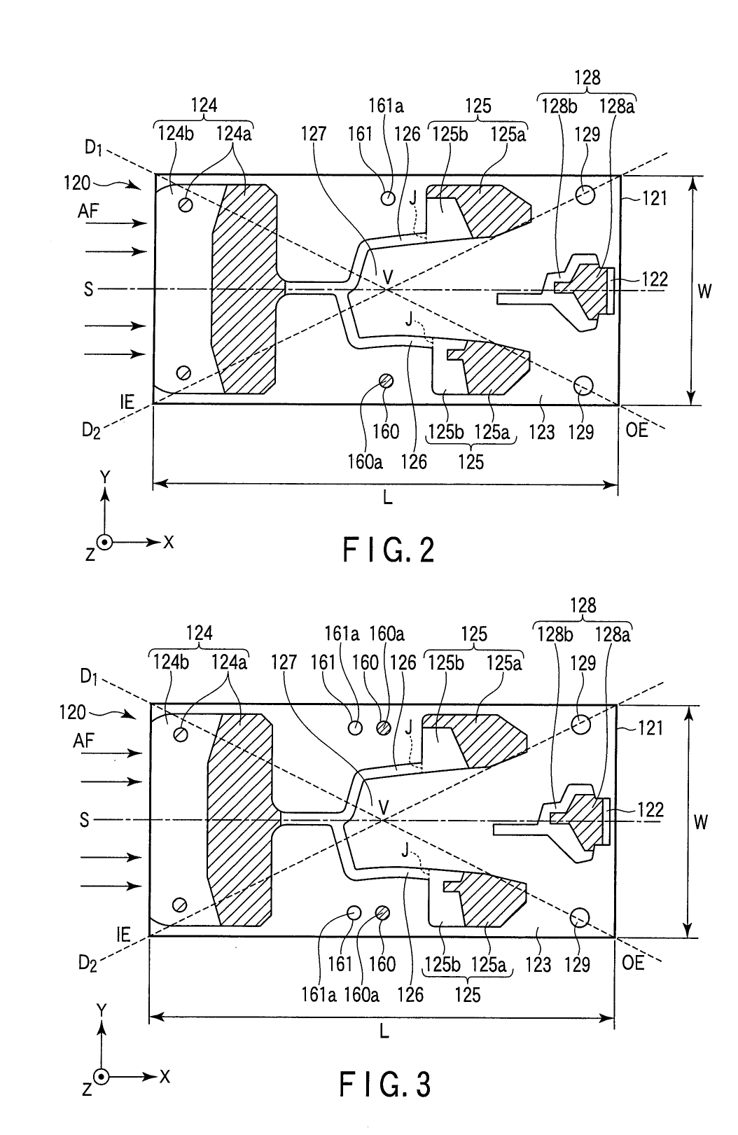

As illustrated in FIGS. 2 and 11B, the magnetic head section 120 comprises a slider 121 and a head 122. FIG. 2 is a plan view illustrating a floating surface 123 of the slider 121 of the magnetic head section 120.

The slider 121 made of Al₂O₃—TiC (AlTiC) is formed into a substantially rectangular shape, and is configured to be able to float from the surface of the disk 104 that rotates while supporting the head 122.

The head 122 is a read/write head configured to reproduce information and records the information in the disk 104, and the head 122 is mounted near an airflow outflow end OE of the slider 121. The head 122 is formed as a head element incorporated film made of Al₂O₃ (alumina). For example, the head 122 of the embodiment is an MR inductive composite head comprising an induction write head element (hereinafter referred to as “inductive head element”) and a magnetoresistive (hereinafter referred to as “MR”) head element. In the inductive head element, binary information is written in the magnetic disk 104 by utilizing a magnetic field generated by a conductive coil pattern (not illustrated). In the MR head element, the binary information is read based on a resistance that changes according to the magnetic field acting from the magnetic disk 104.

The slider 121 and the head 122 define the floating surface 123 that is a medium surface opposite the magnetic disk 104. The floating surface 123 receives an airflow AF produced based on the rotation of the magnetic disk 104.

A first positive pressure section 124, a second positive pressure section 125, a wall section 126, a negative pressure section 127, a third positive pressure section 128, and a wall section 129 are formed in the floating surface 123 of the slider 121. A first identifying section 160 and a second identifying section 161 are also formed in the floating surface 123 of the slider 121.

In the floating surface 123, it is assumed that X is a direction from an airflow incoming end IE to an airflow outgoing end OE, Y is a direction orthogonal to the X-direction, a length L is a distance of the floating surface 123 along the X-direction, and a width W is a distance of the floating surface 123 along the Y-direction. More specifically, the length L and the width W are distances in which the floating surface 123 is projected to a surface that is parallel to the floating surface 123 like an XY plane of FIG. 2, and the length L and the width W are not affected by a step formed on the floating surface 123. A straight line S divides the width W into halves, and is parallel to the X-direction.

An intersection V of diagonals D₁ and D₂ is an outline center of the floating surface 123. A point corresponding to a point V in a surface (not illustrated) of the slider 121 on the side opposite from the floating surface 123 or a point offset from the point corresponding to the point V is a pressurizing point of the suspension 130. As shown in FIGS. 11A and 11B, the suspension 130 comprises a projection 132 that applies elastic force to the slider 121 toward the disk 104, and a pressurizing point CP is where the projection 132 comes into contact with the slider 121.

In the embodiment, the slider 121 is of a long femto type, and has the length L of 0.85 mm≦L≦1.85 mm, the width W of 0.70 mm, and a depth H of 0.23 mm.

The long femto type slider has the depth (longitudinal direction of the slider 121) longer than that of a femto type slider (0.85 mm×0.70 mm×0.23 mm). The femto type slider is formed by cutting a larger size when cut out from a wafer, so that the number of long femto type sliders cut out from one wafer can become identical to that of the femto type sliders even if the femto type slider is changed to the long femto type slider. On the other hand, in the long femto type slider, an area of the floating surface 123 becomes about half a pico type (1.25 mm×1.0 mm×0.3 mm), a positive pressure amount and a negative pressure amount are considerably decreased, and floating amount is also largely decreased. The embodiment is effectively applied to the long femto type slider in which the high-accuracy floating control is required.

The first positive pressure section 124, the second positive pressure section 125, and the third positive pressure section 128 have the function of generating the floating force (positive pressure) that causes the slider 121 to float in conjunction with the airflow AF formed by the rotating disk 104.

The first positive pressure section 124 defines a pitch angle of the slider 121. The first positive pressure section 124 has a substantially rectangular shape that is symmetrical in relation to the straight line S. The first positive pressure section 124 comprises an air bearing surface (ABS) section 124a that exerts a positive pressure effect and a step section 124b that enhances a buoyant force generating function exerted by the ABS section 124a. The step section 124b is provided on the airflow incoming end side of the ABS section 124a.

The ABS section 124a is formed near the airflow incoming end IE into a pair of symmetrically circular shapes with respect to the straight line S, and is formed immediately after the step section 124b into a substantially symmetrically rectangular shape with respect to the straight line S. The step section 124b is symmetrically formed in the substantial Y-direction from the airflow incoming end IE with respect to the straight line S. The ABS section 124a is formed at a level higher than that of the step section 124b.

A region that is substantially symmetrically located between the ABS section 124a and the wall section 126 with respect to the straight line S has a level identical to that of the negative pressure section 127.

The second positive pressure section 125 has the function of establishing a balance in the Y-direction of the slider 121, and the pair of second positive pressure sections 125 is horizontally provided with respect to the straight line S. The pair of second positive pressure sections 125 is also called a side island. The second positive pressure section 125 comprises an ABS section 125a that exerts the positive pressure effect and a step section 125b that enhances the buoyant force generating function exerted by the ABS section 125a. The step section 125b is provided on the airflow incoming end side of the ABS section 125a. The ABS section 125a has a level identical to that of the ABS section 124a while differing from the ABS section 124a in the shape and the size. The step section 125b has a level identical to that of the step section 124b while differing from the step section 124b in the shape and the size.

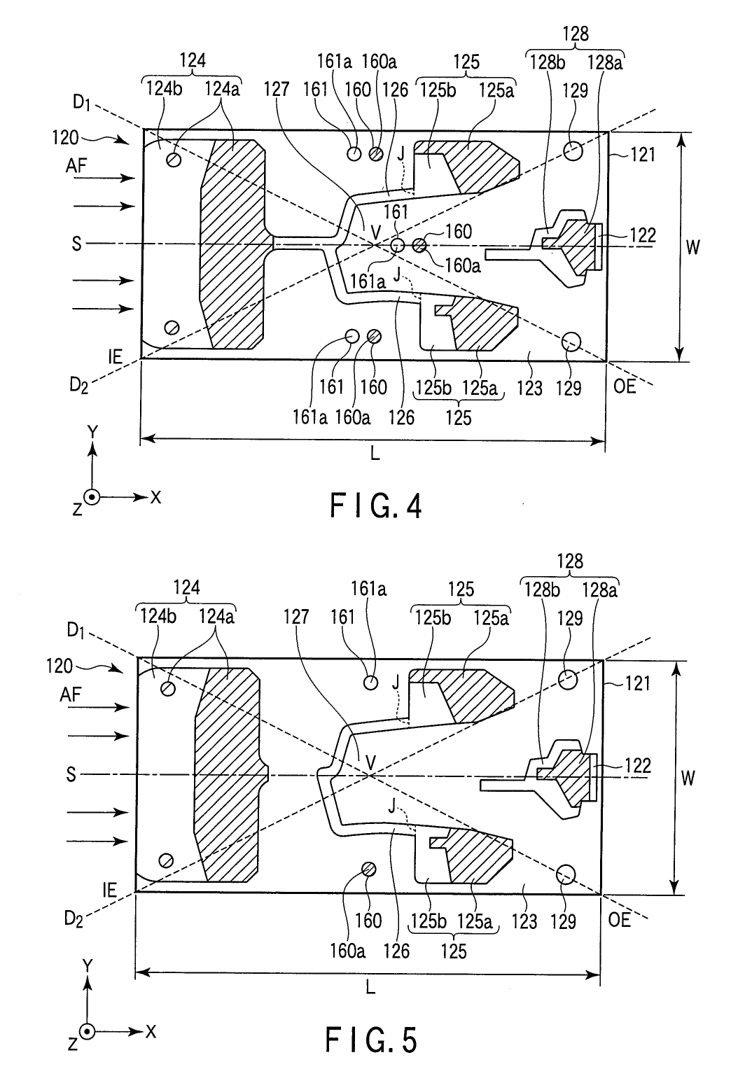

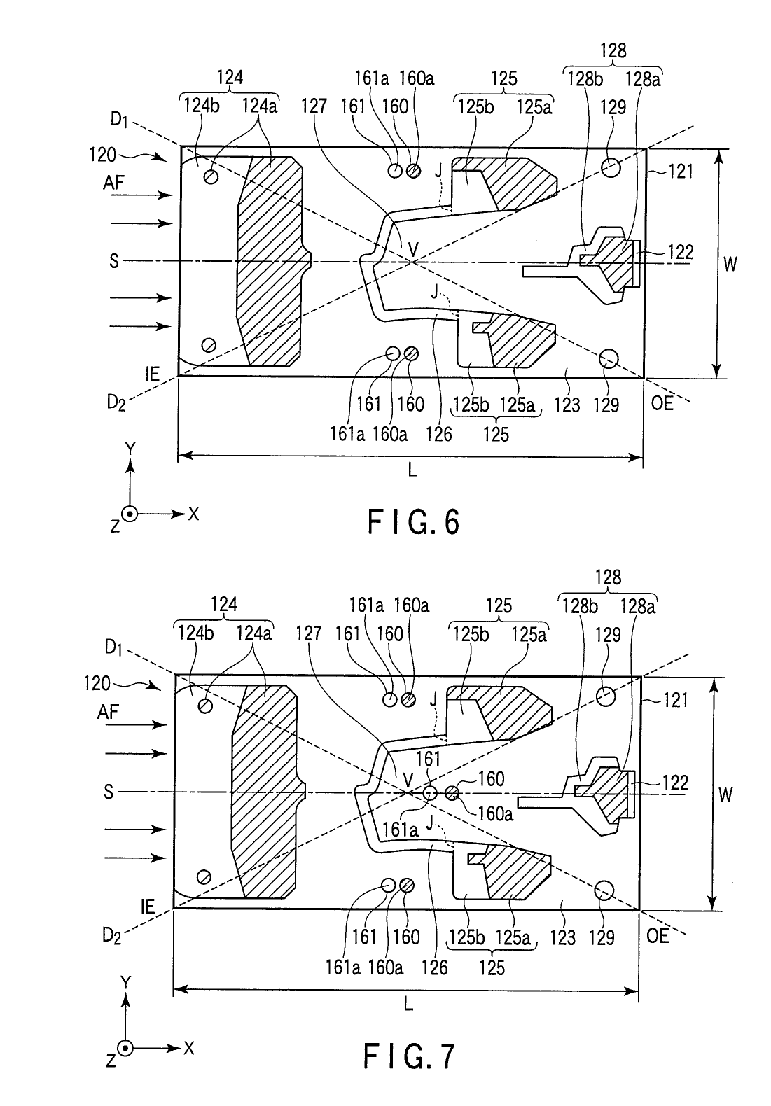

In the embodiment, the wall section 126 has a level identical to that of the step section 124b to define the negative pressure section 127. A boundary line J indicated by a dotted line is a boundary between the wall section 126 and the step section 125b of the second positive pressure section 125. The wall section 126 and the step section 125b have the identical level, and are formed through the identical process. In FIG. 2, the wall section 126 has a substantial Y-shape while being joined to the ABS section 124a. Alternatively, as illustrated in FIGS. 5 to 7, the wall section 126 may have a substantial U-shape while being not joined to the ABS section 124a. FIGS. 5 to 7 are schematic plan views of a magnetic head section 120A that is a modification of the magnetic head section 120 of FIGS. 2 to 4. More particularly, FIG. 5 differs from FIG. 2 only in the shapes of the positive pressure section and negative pressure section, FIG. 6 differs from FIG. 3 only in the shapes of the positive pressure section and negative pressure section, and FIG. 7 differs from FIG. 4 only in the shapes of the positive pressure section and negative pressure section.

The negative pressure section (cavity section) 127 has the function of lowering the floating slider 121 in conjunction with the airflow AF, and is formed between the wall section 126 and the pair of second positive pressure sections 125. In the negative pressure section 127, negative pressure is generated by closing the airflow incoming end side and the side face. The negative pressure section 127 has a level lower than those of the step section 124a and the wall section 126. An effective area of the negative pressure section 127 that actually exerts the negative pressure effect is an area near the U-shape portion defined by the wall section 126. Accordingly, the position of the negative pressure section 127 is changed by changing the position of the wall section 126.

The third positive pressure section 128 has the function of obtaining a floating amount, and is provided on the air outgoing end side of the head 122 while being adjacent to the head 122. The third positive pressure section 128 comprises an ABS section 128a that exerts the positive pressure effect and a step section 128b that enhances the buoyant force generating function exerted by the ABS section 128a. The step section 128b is provided on the airflow incoming end side of the ABS section 128a. The ABS section 128a has a level identical to that of the ABS section 124a while differing from the ABS section 124a in the shape and the size. The step section 128b has a level identical to that of the step section 124b while differing from the step section 124b in the shape and the size.

The wall section 129 is horizontally symmetrically provided near the airflow outgoing end OE with respect to the straight line S. The wall section 129 has a level identical to that of the wall section 126, and has the function of establishing a horizontal balance with respect to the straight line S of the slider 121.

The first identifying section 160 identifies the position of the floating surface 123. The first identifying section 160 is formed in the floating surface 123, and has a level identical to that of the positive pressure sections, more particularly, those of the ABS sections 124a, 125a, and 128a. The position of the floating surface 123 identified by the first identifying section 160 is a center or a gravity center position (hereinafter occasionally referred to as “gravity center position”) of the positive pressure forces generated by the ABS sections 124a, 125a, and 128a of the positive pressure sections. In the embodiment, because the gravity center position of the positive pressure force is set to a position of an outline center V of the floating surface 123 in design, the gravity center position of the positive pressure force is matched with the intersection V that is the outline center unless a position of a later-mentioned first mask 162 deviates.

The second identifying section 161 identifies the negative pressure section 127 that is mainly defined by the wall section 126. The second identifying section 161 is formed in the floating surface 123, and has a level identical to those of the step sections 124b, 125b, and 128b of the positive pressure sections and the wall sections 126 and 129. The position of the negative pressure section 127 identified by the second identifying section 161 is a center or a gravity center position (hereinafter occasionally referred to as “gravity center position”) of the negative pressure force on the floating surface 123, which is mainly generated by the wall section 126. In order to stabilize the floating amount of the slider 121, it is necessary to consider not only the positive pressure gravity center of the positive pressure force but also the negative pressure force that is smaller than the positive pressure force. In the embodiment, because the gravity center position of the negative pressure force is set to the position of the outline center V of the floating surface 123 in design, the gravity center position of the negative pressure force is matched with the intersection V that is the outline center unless a position of a later-mentioned second mask 164 deviates.

It is assumed that the position of the first mask 162 used to form the ABS sections 124a, 125a, and 128a of the positive pressure sections and the position of the second mask 164 used to form the wall section 126 that mainly defines the negative pressure section 127 do not deviate at all. In such cases, because the gravity center positions of the positive pressure force and negative pressure force are matched with the intersection V that is the outline center of the floating surface 123, the floating attitude of the slider 121 is stabilized even if the slider 121 is mounted on the suspension 130 by the conventional method. However, the gravity center position of the positive pressure force deviates from the intersection V when the position of the first mask 162 deviates, and the gravity center position of the negative pressure force deviates from the intersection V when the position of the second mask 164 deviates. Accordingly, when the intersection V is simply matched with the pressurizing point CP like the conventional method, occasionally the moment is generated while the intersection V is not matched with the centers of the positive pressure and negative pressure, and the floating attitude of the slider 121 is not stabilized.

The floating amount of the slider 121 can be stabilized in consideration of magnitude of each of the three forces and relative positions of the three points, that is, the gravity center position of the positive pressure force identified by the first identifying section 160, the gravity center position of the negative pressure force identified by the second identifying section 161, and the position of the pressurizing point CP of the suspension 130. Because an absolute value of the negative pressure force is smaller than that of the positive pressure force, the case in which only the gravity center position of the positive pressure force is grasped by the first identifying section 160 is also included in the scope of the invention. At this point, when the slider 121 mounted on the suspension 130 is mounted on the HDD 100 and driven, the position identified by the first identifying section 160 and the pressurizing point CP are arrayed on the identical straight line in the vertical direction.

Because the wall section 126 mainly defines the negative pressure section 127, the second identifying section 161 identifies the position of the wall section 126 so as to identify the position of the negative pressure section 127 or the gravity center position of the negative pressure force. In considering the deviation of the negative pressure section 127, when the gravity center position of the negative pressure force deviates from the gravity center position of the positive pressure force, it is necessary that the position of the pressurizing point CP of the suspension 130 be corrected from the gravity center position of the positive pressure force according to the deviated distance and a ratio of the positive pressure force and the negative pressure force.

For example, assuming that the positive pressure force is +4.0 gf, the negative pressure force is −1.0 gf, the pressurizing force of the suspension 130 is −3.0 gf, and the gravity center position of the positive pressure force and the gravity center position of the negative pressure force deviate from each other by 5 μm, as illustrated in FIG. 12, the position of the pressurizing point CP of the suspension 130 is corrected so as to deviate from the gravity center position of the positive pressure force by 5 mm×(1 gf/4 gf)=1.25 mm in the opposite direction to the direction of the gravity center position of the negative pressure force. The corrected position is the moment center position, and the floating amount and floating attitude of the slider 121 can be stabilized by the correction.

FIG. 2 is a plan view illustrating an example of the magnetic head section 120 in which each of the first identifying section 160 and the second identifying section 161 is provided as one circular mark. If the first identifying section 160 and the second identifying section 161 are previously determined to have the circular shape when viewed from the direction perpendicular to the floating surface 123, a center (or gravity center) 160a of the first identifying section 160 and a center (or gravity center) 161a of the second identifying section 161 are easy to find. In FIG. 2, the X-coordinate of the center 160a of the first identifying section 160 is matched with the X-coordinate of the gravity center position of the positive pressure force (or the intersection V unless the position of the first mask 162 deviates), and the X-coordinate of the center a of the second identifying section 161 is matched with the X-coordinate of the gravity center position of the negative pressure force (or the intersection V unless the position of the second mask 164 deviates).

FIG. 3 is a plan view illustrating an example of the magnetic head section 120 in which each of the first identifying section 160 and the second identifying section 161 is provided as a pair of circular marks. FIG. 4 is a plan view illustrating an example of the magnetic head section 120 in which each of the first identifying section 160 and the second identifying section 161 is provided as three circular marks.

There is no limitation to the number of marks constituting the first identifying section 160 and the second identifying section 161. The use of the two marks can set the midpoint of the line segment connecting the centers or gravity centers of the marks to the reference. The use of the three marks can set the gravity center, the incenter, or the circumcenter of the triangle connecting the centers or gravity centers of the marks to the reference. The reliability of position detection can be secured by the redundancy.

As illustrated in FIG. 2, when one mark constitutes each of the first identifying section 160 and the second identifying section 161, it is considered that the mark is also formed at the intersection V that is the outline center of the floating surface 123 or the point offset from the intersection V. However, in FIG. 2, because the position is located in the negative pressure section 127, the mark is provided outside the wall section 126 so as not to interfere with the negative pressure effect. In the embodiment, the position that is moved by a predetermined distance in the X-direction and the Y-direction from the centers of the marks or the gravity centers of the first identifying section 160 and the second identifying section 161 is set to the intersection V or the point offset from the intersection V. Particularly, in FIG. 2, the first and second identifying sections 160 are provided on the opposite sides with respect to the straight line S, and are provided at equal distance in the width direction with respect to the straight line S thereby maintaining the floating balance between both the sides with respect to the straight line S.

The first identifying section 160 and the second identifying section 161 are not always provided in the negative pressure section 127. When the influence on the negative pressure effect exists in a permissible range even if the first identifying section 160 and the second identifying section 161 are provided in the negative pressure section 127, and when the first identifying section 160 and the second identifying section 161 are determined to be preferably provided in the negative pressure section 127 from the standpoint of the maintenance of the floating attitude, part of or all the marks constituting the first identifying section 160 and second identifying section 161 may be provided in the negative pressure section 127 as illustrated in FIG. 4.

The suspension 130 comprises the projection 132 that applies the elastic force to the magnetic head section 120 against the magnetic disk 104 while supporting the magnetic head section 120. The suspension 130 also comprises a flexure (occasionally called by another name such as a gimbal spring) that cantilevers the magnetic head section 120 and a load beam (occasionally called by another name such as a load arm) that is connected to the base plate. The suspension 130 also supports a wiring section (not illustrated) that is connected to the magnetic head section 120 through a lead wire. The sense current, the write information, and the read information are supplied and output between the head 122 and the wiring section through the lead wire.

The influence of the mask alignment error can be canceled in forming the positive pressure section, when the position of the floating surface 123 identified by the first identifying section 160, the position of the negative pressure section identified by the second identifying section 161, and the pressurizing point CP at which the projection 132 comes into contact with the slider 121 exist on the identical straight line parallel with the vertical direction. The vertical direction is the Z-direction perpendicular to the paper plane of FIG. 2.

The positive pressure section deviates in the X-direction and Y-direction, when the alignment error exists between the mask and the floating surface 123 of the slider 121 in forming the positive pressure section. In the embodiment, the pressurizing point CP is not matched with the intersection V that is the apparent outline center of the floating surface 123 or the point offset from the intersection V in the Z-direction, but the pressurizing point CP is matched with a point to which the intersection V or the point offset from the intersection V deviates by the alignment error in the Z-direction. The deviated point is identified with the first identifying section 160 and the second identifying section 161. As described later, the first identifying section 160 is formed using the identical mask 162 that is used to form the ABS section of the positive pressure section, and the second identifying section 161 is formed using the identical mask 164 that is used to form the step section and wall section of the positive pressure section, so that the deviated point can accurately be identified.

The carriage 140 oscillates about the support shaft 144 by a voice coil motor (not illustrated). Because an actuator section of the carriage 140 has a substantial E-shape, the carriage 140 is also called an E block or an actuator (AC) block. A support section of the carriage 140 is called an arm 142, and the arm 142 is an aluminum rigid body that is provided so as to rotate or oscillate about the support shaft 144. A flexible circuit board (FPC) is also provided in the carriage 140. The flexible circuit board (FPC) supplies a control signal, a signal to be recorded in the disk 104, and electric power to the wiring section, and receives a signal reproduced from the disk 104.

For example, the spindle motor 150 rotates the magnetic disk 104 at high speed of 10000 rpm.

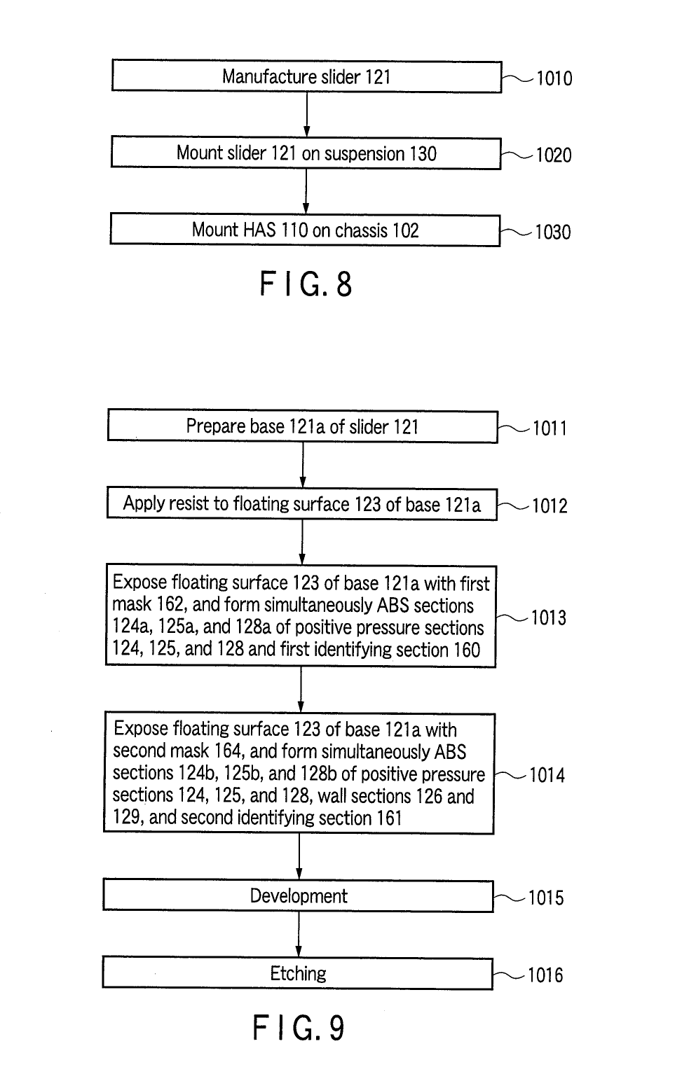

A method for manufacturing the HDD 100 will be described below with reference to FIG. 8. FIG. 8 is an exemplary flowchart illustrating the method for producing the HDD 100. At first the slider 121 is manufactured (Block 1010). Then the slider 121 is mounted on the suspension 130 (Block 1020). Then the HAS 110 is mounted on the chassis 102 (Block 1030). Block 1010 acts as the slider producing method, and Blocks 1010 and 1020 act as the suspension assembly producing method.

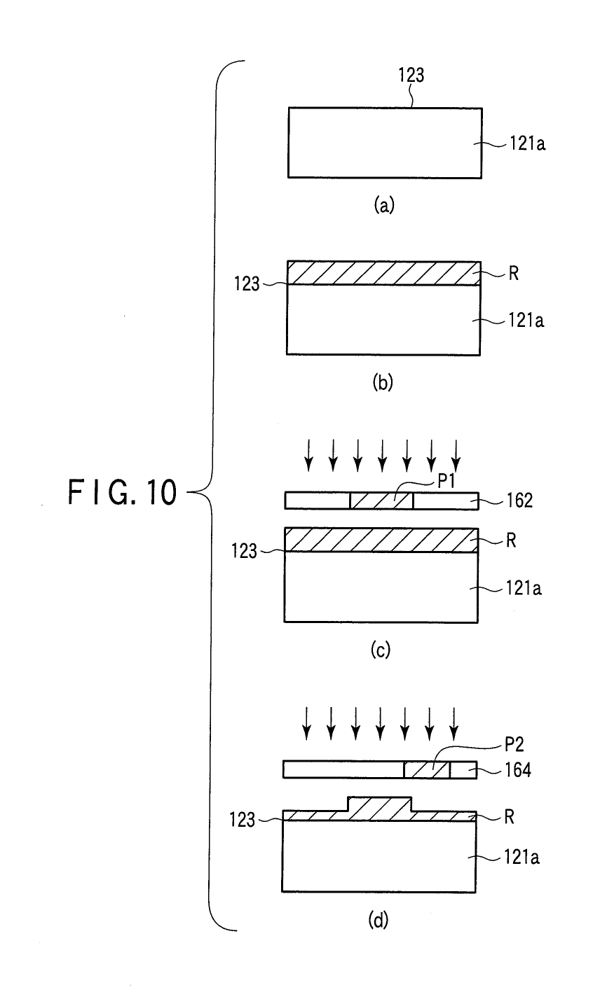

Block 1010 will be described in detail with reference to FIGS. 9 and 10A to 10D. FIG. 9 is a flowchart illustrating the manufacturing method in Block 1010. FIGS. 10A to 10D are schematic sectional views illustrating a state in each block of FIG. 9.

As illustrated in FIG. 10A, the base 121a of the slider 121 is prepared (Block 1011). As illustrated in FIG. 10B, a resist R is applied to the floating surface 123 of the base 121a (Block 1012). As illustrated in FIG. 10C, the floating surface 123 of the base 121a is exposed using the first mask 162 (Block 1013). In the first mask 162, the ABS sections 124a, 125a, and 128a of the positive pressure sections 124, 125, and 128 and the first identifying section 160 are formed as a pattern P1 of a light blocking portion. Obviously the light blocking portion and light transmitting portion of the first mask 162 may be replaced with each other when the type of the resist R is changed from the positive type resist to the negative type resist. Through Block 1013, the positive pressure sections 124, 125, and 128 and the first identifying section 160 can be formed by utilizing the identical mask 162.

As illustrated in FIG. 10D, the floating surface 123 of the base 121a is exposed using the second mask 164 (Block 1014). In the second mask 164, the step sections 124b, 125b, and 128b of the positive pressure sections 124, 125, and 128, the wall sections 126 and 129, and the second identifying section 161 are formed as a pattern P2 of the light blocking portion. Obviously the light blocking portion and light transmitting portion of the second mask 164 may be replaced with each other when the type of the resist R is changed from the positive type resist to the negative type resist.

Then the development of the base 121a is performed (Block 1015), and etching is performed (Block 1016), thereby obtaining one of the sliders 121 of FIGS. 2 to 7.

In Block 1030, when the influence of the negative pressure section 127 having the small pressure is ignored, the slider 121 is mounted on the suspension 130 such that the gravity center position, identified by the first identifying section 160, of the positive pressure force generated by the positive pressure section in the floating surface 123 and the pressurizing point CP at which the projection 132 comes into contact with the slider 121 exist on the identical straight line parallel to the Z-direction. When the influence of the negative pressure from the negative pressure section 127 is considered, the slider 121 is mounted on the suspension 130 such that the moment center position and the pressurizing point CP at which the projection 132 comes into contact with the slider 121 exist on the identical straight line parallel to the Z-direction. The moment center position is obtained from the positive pressure force generated by the positive pressure section in the floating surface 123 and the gravity center position thereof identified by the first identifying section 160, and the negative pressure force generated by the negative pressure section 127 and the gravity center position thereof identified by the second identifying section 161. In mounting the slider 121 on the suspension 130, it is necessary that the pressurizing point CP and the position identified by the first identifying section 160 or the pressurizing point CP and the moment center position be matched with each other in the Z-direction using one or plural cameras.

In the operation of the HDD 100, the spindle motor 150 is driven to rotate the disk 104. The airflow associated with the rotation of the disk 104 is involved between the slider 121 and the disk 104 to form an extremely thin air film. The buoyant force acts on the slider 121 by the air film and the first to third positive pressure sections 124, 125, and 128 such that the slider 121 floats from the disk surface. On the other hand, the air film and the negative pressure section 127 generate the negative pressure in the slider 121 such that the negative pressure reduces the buoyant force. The suspension 130 applies the elastic pressing force to the slider 121 through the projection 132 in the direction opposite the buoyant force of the slider 121. As a result, a balance is established between the buoyant force (positive pressure) and (negative pressure+elastic force).

In the embodiment, even if the alignment error between the first mask 162 and the floating surface 123 is generated in exposing the pattern of the first mask 162 to the resist R on the floating surface 123, or even if the alignment error between the second mask 164 and the floating surface 123 is generated in exposing the pattern of the second mask 164 to the resist R on the floating surface 123, the position corresponding to the pressurizing point CP can be corrected according to the positions identified by the first identifying section 160 and the second identifying section 161. Therefore, the floating slider 121 is stabilized without collapsing the floating attitude.

The magnetic head section 120 and the disk 104 are separated from each other with a constant distance by the balance between the buoyant force (positive pressure) and (negative pressure+elastic force). Then the carriage 140 is turned about the support shaft 144 to move the head to a target track on the disk 104. During the write, data is obtained from a superior device such as a PC (not illustrated) through the interface, the data is modulated and supplied to the inductive head, and the data is written in the target track through the inductive head. During the read, a predetermined sense current is supplied to the MR head, and the MR head reads the desired information from the desired track of the disk 104.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A slider of a magnetic head, the magnetic head is configured to record information in a disk and to reproduce information from the disk, the slider being configured to fly from a surface of the disk, the slider comprising:
a floating surface facing the surface of the disk;
a positive pressure generator in the floating surface, configured to produce floating force in conjunction with airflow due to a rotation of the disk; and
a first identifier comprising a height of the positive pressure generator and configured to identify a gravity center position of positive pressure force generated by the positive pressure generator.

2. The slider of claim 1, wherein the first identifier comprises a circular shape from a direction perpendicular to the floating surface.

3. The slider of claim 1, wherein the first identifier comprises one or a plurality of marks.

4. The slider of claim 1, further comprising:
a wall configured to define a negative pressure generator configured to reduce the floating force; and
a second identifier comprising a height of the wall in the floating surface and configured to identify a gravity center position of negative pressure force generated by the negative pressure generator.

5. The slider of claim 4, wherein the second identifier comprises a circular shape from a direction perpendicular to the floating surface.

6. The slider of claim 4, wherein the second identifier comprises one or a plurality of marks.

7. A storage device comprising:
a driver configured to support a storage disk and to rotate the storage disk;
a magnetic head comprising a slider configured to fly from a surface of the disk and a head portion on the slider configured to record information in the storage disk and to reproduce information from the storage disk; and
a suspension assembly configured to support the magnetic head and to drive the magnetic head;
the slider comprising:
a floating surface facing the surface of the storage disk;
a positive pressure generator in the floating, configured to produce floating force in conjunction with airflow due to a rotation of the disk; and
a first identifier comprising a height of the positive pressure generator and configured to identify a gravity center position of positive pressure force generated by the positive pressure generator.

8. A method of manufacturing a suspension assembly comprising a slider of a magnetic head, the magnetic head is configured to record information in a disk and to reproduce information from the disk, the method comprising:
manufacturing a slider comprising a floating surface and a positive pressure generator, the manufacturing comprising:
forming a first identifier with using an identical mask, the first identifier being configured to identify a gravity center position of positive pressure force generated by the positive pressure generator in the floating surface; and
attaching the slider on a suspension comprising a projection configured to apply elastic force toward the disk to the slider.

9. The method of claim 7, wherein the manufacturing the slider further comprises:
forming a wall configured to define a negative pressure generator in the floating surface, the negative pressure generator being farther away from the disk than the positive pressure generator in order to reduce floating force; and
forming a second identifier in the floating surface by using an identical mask, the second identifier being configured to identify a gravity center position of negative pressure force generated by the negative pressure generator.
